(19) United States
(12) Patent Application Publication
(10) Pub. No.: US 2009/0247164 A1
(43) Pub. Date: Oct. 1, 2009

(54) HANDOFF ALGORITHM AND ARCHITECTURE FOR MOBILE SYSTEM

(75) Inventors: Sunil Kumar Kandukuri Narayan, San Diego, CA (US); Mohammad J. Borran, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/361,689

(22) Filed: Jan. 29, 2009

Related U.S. Application Data
(60) Provisional application No. 61/040,575, filed on Mar. 28, 2008.

(51) Int. Cl. H04W 36/00

(52) U.S. Cl. 455/436

(57) ABSTRACT

A reference signal and handoff management (RSHM) program executing on a mobile device detects reference signals, allocates them into groups, and performs handoffs between synchronous and asynchronous sectors. Sectors are allocated to an active group. Sectors from the active group that satisfy a channel quality constraint are allocated to a second group. Sectors from the second group that satisfy a link budget constraint are allocated to a third group. The RSHM program calculates a weighted characteristic of the forward and reverse links of sectors in the third group. The RSHM program performs handoffs from current serving sectors to sectors having the largest weighted characteristic that exceeds the weighted characteristic of the current serving sector by an hysteresis amount. Battery power of the mobile device is efficiently used to perform handoffs and to manage reference signals in heterogeneous network environments by preventing unnecessary handoffs, overhead downloads, access probes and new registrations.

### CROSS-REFERENCE TO RELATED APPLICATION

This application claims the benefit under 35 U.S.C. §119 of Provisional Application Ser. No. 61/040,575, filed on Mar. 23, 2008, assigned to the assignee hereof and incorporated herein by reference.

### BACKGROUND INFORMATION

1. Technical Field

The present disclosure relates generally to wireless communication devices and, more specifically, to managing reference signals in order more efficiently to perform handoffs in a wireless communication system.

2. Background Information

Mobile subscribers consider long battery life to be a positive attribute of a mobile device, such as a cell phone. Battery life is typically described in terms of talk time and standby time. Even when a mobile subscriber is not carrying on a conversation, the cell phone still consumes power. Standby time is the length of time a battery can power a cell phone even when no calls are made. When a cell phone is turned on, the cell phone typically first acquires reference signals (also called pilot signals) before transmitting and receiving voice traffic over a traffic channel. For example, in some radio technologies, pilot signals are received over pilot, synchronization and paging channels. Once pilot signals are acquired, power is conserved by shutting down certain circuitry in the cell phone until a call is received or made. Other circuitry, however, must nevertheless be powered to detect whether the cell phone is receiving a call. Certain circuitry is turned on periodically to monitor the pilot signals transmitted over the pilot, synchronization and paging channels.

Even periodically monitoring pilot signals, however, consumes power. Moreover, power is consumed when the cell phone is handed off between access points of a wireless communications system. More power is consumed when the mobile device is operated in a heterogeneous network environment in which pilot signals are received from multiple wireless communication systems implementing multiple radio technologies. For example, a cell phone may be operated in a heterogeneous network environment in which access points operate using differing modulation techniques, such as code division multiple access (CDMA), time division multiple access (TDMA), frequency division multiple access (FDMA), orthogonal frequency division multiple access (OFDMA) and the modulation protocol defined by 3GPP LTE. CDMA modulation is employed by the radio technologies of cdma2000 and Universal Terrestrial Radio Access (UTRA). TDMA modulation is used by the Global System for Mobile Communications (GSM). OFDMA is used by radio technologies such as Evolved UTRA (E-UTRA), IEEE 802.11, IEEE 802.16, IEEE 802.20 and Flash-OFDM. Monitoring the multiple pilot signals received from access points that implement these various radio technologies and handing off between the access points consumes a significant amount of power.

Less power is consumed if pilot signals are acquired less frequently and if complex computations are performed less frequently on the pilot signals that are acquired. Standby time increases when fewer pilot signals are acquired and when fewer computations are performed on those acquired pilot signals. Moreover, less power is consumed if the number of unwanted handoffs is reduced. Thus, a method is sought for extending standby time by efficiently managing pilot signals received from heterogeneous access points and by efficiently performing handoffs even between heterogeneous access points.

### SUMMARY

A reference signal and handoff management (RSHM) program executing on an access terminal detects multiple reference signals, allocates the detected reference signals into groups of reference signals, performs reference signal management functions, and performs handoffs between synchronous and asynchronous sectors using information conveyed in the detected reference signals. Battery power of the access terminal is efficiently used to perform handoffs and to manage reference signals in a heterogeneous network environment by preventing unnecessary handoffs, overhead downloads, access probes and new registrations.

Handoffs are performed between sectors that implement different radio technologies or that use the same system technology but have different configurations. Reference signals are managed in idle mode as well as in connected state mode from sectors that are not necessarily synchronous to each other. The RSHM program maintains updated groups of sectors, including a candidate group, a remaining group, an active group, a preferred sector list, a paging group, an access group and a serving sector group. Firmware blocks of the RSHM program provide a handoff block with updated overhead parameters of prospective desired serving sectors, such as the power of carrier-over-thermal (pCoT), the channel difference (ChanDiff), AvgPilotEnergyTDM, AvgPilotEnergyBeacon, the link budget as indicated by the power spectral density of the reverse link broadband pilot channel (P_{R-PICH}), the interference over thermal (IoT) and the rise over thermal (RoT).

The RSHM program uses the updated overhead parameters and the updated groups of sectors to perform functions such as managing handoffs between access points, managing the idle mode of the access terminal, managing the active group of sectors, and collecting system configuration information for the access terminal. In a connected state mode of the access terminal, the RSHM program detects reference signal energies of both broadband TDM acquisition reference signals and narrowband single-tone reference (beacon) signals.

In one embodiment, the RSHM programs performs a handoff from a current serving sector to a desired serving sector by allocating those sectors from which reference signals are detected to an active group of sectors. Sectors from the active group of sectors that satisfy a reverse link channel quality constraint are allocated to a second group of sectors. If the current serving sector has been allocated to the second group of sectors, then those sectors from the second group of sectors that satisfy a reverse link budget constraint are allocated to a third group of sectors. The RSHM program then calculates a magnitude of a weighted characteristic for each sector in the third group of sectors. The weighted characteristic is weighted between the characteristic of the forward link of each sector and the characteristic of the reverse link of that sector.

In one implementation of the embodiment, the characteristic is channel quality. The characteristic of the forward link is measured using an energy parameter, and the characteristic of the reverse link is measured using the channel quality indicator pCoT (power of carrier-over-thermal). The RSHM program determines that a prospective desired serving sector is the desired serving sector based on both the reverse link channel quality constraint and the reverse link budget constraint of the prospective desired serving sector. More specifically, the RSHM program identifies the desired serving sector based on that sector having the largest magnitude of the weighted characteristic of sectors in the third group if that largest magnitude exceeds the magnitude of the weighted characteristic of the current serving sector by more than an hysteresis amount. The RSHM program performs a handoff from the current serving sector to the identified desired serving sector.

In another embodiment, the RSHM program identifies the desired serving sector without allocating sectors to a third group of sectors. The RSHM program performs a handoff from a current serving sector to a desired serving sector by allocating to the active group those sectors from which reference signals are detected. Sectors from the active group of sectors that satisfy a reverse link channel quality constraint are allocated to the second group of sectors. If the current serving sector is not among the second group of sectors, then no third group of sectors is formed. Instead, the RSHM program calculates a magnitude of a weighted characteristic for each sector in the second group of sectors, wherein the weighted characteristic is weighted between the characteristic of the forward link of each sector and the characteristic of the reverse link of that sector. The RSHM program determines that a prospective desired serving sector is the desired serving sector based on that sector having the largest magnitude of the weighted characteristic of sectors in the second group if that largest magnitude exceeds the magnitude of the weighted characteristic of the current serving sector by more than the hysteresis amount. The RSHM program then performs a handoff from the current serving sector to the identified desired serving sector.

In yet another embodiment, an access terminal includes a processor, a storage medium, and a reference signal and handoff management (RSHM) program. The RSHM program is stored on the storage medium and includes a handoff management module and firmware modules. The RSHM program includes instructions that are executed by the processor to cause the access terminal to detect reference signals. The instructions of the handoff management module are executed by a software subprocessor of the processor. The instructions of the firmware modules are executed by a firmware subprocessor of the processor. The handoff management module polls the firmware modules for link quality information obtained from the reference signals and applies a reverse link channel quality constraint to each sector from which a reference signal is detected. The instructions also cause the access terminal to allocate to a first group of sectors each sector from which a reference signal is detected indicating that the sector satisfies a reverse link channel quality constraint. The instructions that are executed by the processor also cause the access terminal to calculate a magnitude of a weighted characteristic for each sector in the first group of sectors. The access terminal determines that a sector from the first group is the desired serving sector based on the reverse link channel quality of the sector. The access terminal also determines that a sector from the first group is the desired serving sector based on the sector having the largest magnitude of the weighted characteristic. In one implementation of the embodiment, the instructions that are executed by the processor also cause the access terminal to allocate to a second group each sector from the first group for which a reference signal indicates that the sector satisfies a reverse link budget constraint. The instructions also cause the access terminal to perform a handoff of the access terminal from the current serving sector to the desired serving sector.

In yet another embodiment, the execution of a set of processor-executable instructions stored on a processor-readable medium causes a device for managing handoffs to perform operations including detecting reference signals, allocating sectors to a group of sectors, calculating the magnitude of a weighted characteristic, designating a desired serving sector, and performing a handoff of an access terminal. The detected reference signals are received by the access terminal over forward links from sectors. Each of the sectors that is allocated to the group of sectors satisfies a reverse link channel quality constraint. The weighted characteristic is weighted between the characteristic of the forward link of each sector and the characteristic of the reverse link of that sector. The desired serving sector is designated from among the group of sectors as being the sector having the largest magnitude of the weighted characteristic. The execution of the instructions causes the device for managing handoffs to handoff the access terminal from the current serving sector to the desired serving sector. In one implementation, the current serving sector and the desired serving sector are asynchronous with one another.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 is an illustration of an access terminal receiving reference signals according to one embodiment;

FIG. 2 is a block diagram of an embodiment of a wireless communication system in which an access terminal receives reference signal data from an access point;

FIG. 3 is a diagram of a reference signal and handoff management (RSHM) program on the access terminal of FIG. 3 that performs connection and handoff functions by generating a matrix, database and groups using reference signals;

FIG. 4 is a block diagram illustrating software blocks of the reference signal and handoff management program of FIG. 3 that perform various reference signal management tasks;

FIG. 5 is a diagram illustrating how the reference signal and handoff management program of FIG. 3 allocates detected reference signals into groups and subgroups;

FIG. 6 illustrates an exemplary heterogeneous network topology in which the reference signal and handoff management program of FIG. 3 manages reference signals and performs connection and handoff functions;

FIG. 7 is a flowchart of steps performed by the reference signal management program of FIG. 3 to manage reference signals and to perform connection and handoff functions;

FIG. 8 is a block diagram illustrating software blocks of another embodiment of the reference signal and handoff management program that manages the handoff between both synchronous and asynchronous sectors; and

FIG. 9 is a flowchart of steps performed by the reference signal and handoff management program of FIG. 3 to designate a desired serving sector and to perform the handoff of an access terminal from a current serving sector to a desired serving sector.

### DETAILED DESCRIPTION

The techniques described herein are advantageously applied in heterogeneous network environments in which multiple wireless communication networks implement different radio technologies. For example, the multiple wireless communication networks may use various modulation techniques, such as Code Division Multiple Access (CDMA), Time Division Multiple Access (TDMA), Frequency Division Multiple Access (FDMA), Orthogonal FDMA (OFDMA), and Single-Carrier FDMA (SC-FDMA). A CDMA network may implement radio technologies such as Universal Terrestrial Radio Access (UTRA) and cdma2000. UTRA includes Wideband-CDMA (W-CDMA) and Low Chip Rate (LCR). cdma2000 covers the IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20 and Flash-OFDM®. For example, a version of OFDMA called Scalable OFDMA is employed by the IEEE 802.16 WiMAX (Worldwise Interoperability for Microwave Access) specification. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2).

Single carrier frequency division multiple access (SC-FDMA) utilizes single carrier modulation and frequency domain equalization. SC-FDMA has similar performance and essentially the same overall complexity as those of OFDMA. An SC-FDMA signal has lower peak-to-average power ratio (PAPR) than does an OFDMA signal because of the inherent single carrier structure. SC-FDMA has drawn great attention, especially in the uplink communications where lower PAPR greatly benefits the mobile access terminal in terms of transmit power efficiency. SC-FDMA is currently a popular modulation technique for uplink multiple access schemes in 3GPP LTE and Evolved UTRA.

These radio technologies may support time division duplexing (TDD) or frequency division duplexing (FDD) or both. For example, FDD is employed in 3GPP LTE, Ultra-Mobile Broadband (UMB) also known as Evolution-Data Optimized Revision C, and FDD WiMax (IEEE 802.16). There are both FDD and TDD versions of W-CDMA. In a TDD system, the forward and reverse link transmissions use the same frequency band. FDD transceivers, on the other hand, independently generate the transmit and receive frequencies. These various radio technologies and standards are known in the art. For clarity, certain aspects of the techniques are described below for 3GPP LTE, and 3GPP LTE terminology is used in much of the description below. The aspects disclosed herein may also be applied to the other radio technologies listed above.

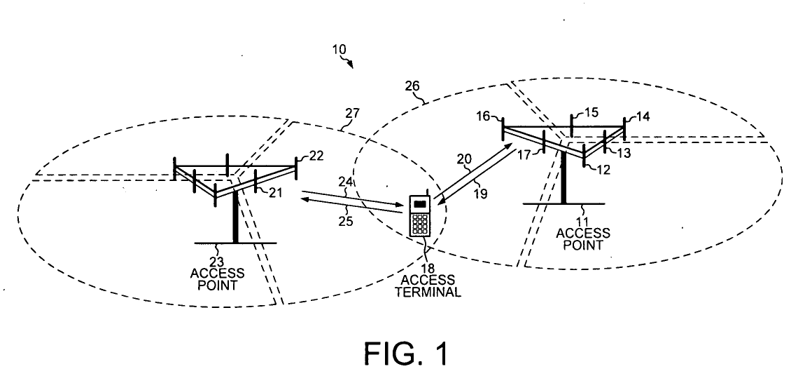

FIG. 1 illustrates a multiple-access wireless communication system 10 according to one embodiment. An access point 11 includes multiple antenna groups. One antenna group includes 12 and 13, another includes 14 and 15, and an additional group includes 16 and 17. Although in FIG. 1 only two antennas are shown for each antenna group, more or fewer antennas may be utilized for each antenna group.

Each access terminal communicates with one or more access points via transmissions on forward and reverse links. The forward link (or downlink) refers to the communication link from the access point to the access terminal, and the reverse link (or uplink) refers to the communication link from the access terminal to the access point. In FIG. 1, an access terminal 18 is in communication with antennas 16 and 17, where antennas 16 and 17 transmit information to access terminal 18 over a forward link 19 and receive information from access terminal 18 over reverse link 20. Access terminal 18 is also in communication with antennas 21 and 22 of another access point 23, where antennas 21 and 22 transmit information to access terminal 18 over forward link 24 and receive information from access terminal 18 over reverse link 25. In an FDD system, communication links 19, 20, 24, 25 may use different frequencies for communication. For example, forward link 19 may use a different frequency than that used by reverse link 20. Access points 11 and 23 may be fixed stations used for communicating with access terminals and are also referred to as base stations, Node Bs or some other terminology. Access terminal 18 may also be called user equipment (UE), a wireless communication device, a terminal, a cell phone, a mobile telephone or some other terminology.

Each group of antennas and the area in which they are designed to communicate is often referred to as a sector of the access point. In this embodiment, each antenna group is designed to communicate with access terminals in one sector of the areas covered by access points 11 and 23. FIG. 1 shows that access point 11 has three sectors, and access point 22 also has three sectors. Access terminal 18 is in communication with a sector 26 of access point 11 and with a sector 27 of access point 23. When the user of access terminal 18 is not sending or receiving voice or data traffic, access terminal 18 is in an idle mode. Alternatively, access terminal 18 is in a connected state mode when voice or data traffic is being sent to or received from the user of access terminal 18. When access terminal 18 is in the connected state mode and is in communication with antennas 16 and 17, sector 26 is said to be a serving sector. Sector 27 is a non-serving sector because although access terminal 18 is in communication with sector 27, the user of access terminal 18 is not sending or receiving voice or data traffic to or from sector 27. In communication over forward link 19, the transmitting antennas of access point 11 utilize beamforming in order to improve the signal-to-noise ratio of forward link 19.

A method is disclosed for selecting serving sectors and for performing handoffs of an access terminal on both the forward and reverse links. The method is implemented on the access terminal and performs handoffs of the access terminal from a serving sector to a desired serving sector (DSS). The method is efficiently implemented by partitioning the tasks to be performed between software stored on erasable memory and firmware stored on non-volatile memory. The method enables handoffs to be performed between both synchronous and asynchronous sectors. The criterion for performing handoffs is based on the sum of metrics for the forward and reserve links, in which varying weightings are applied to the forward and reverse link channel qualities. The reverse link budget constraints of the desired serving sector are also taken into account when deciding whether to handoff to the desired serving sector. The method performs handoffs seamlessly between sectors that are asynchronous to one another without affecting the RLP and upper-layer connections. Because both the channel quality and the reverse link budget constraints are taken into account, the number of unwanted handoffs is reduced.

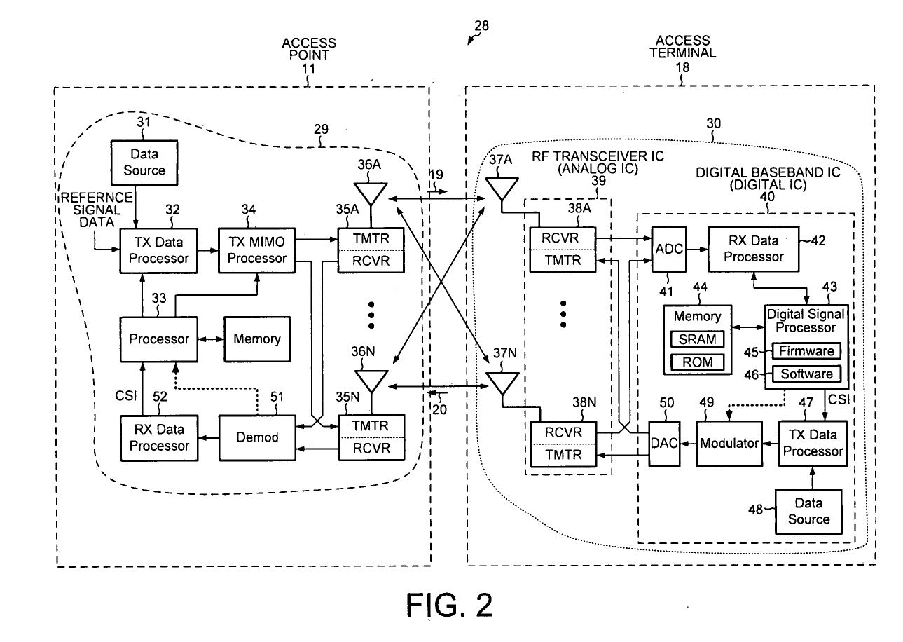

FIG. 2 is a block diagram of an embodiment of a multiple-in-multiple-out (MIMO) wireless communication system 28 in which access terminal 18 is in communication with access point 11. Access point 11 includes a transceiver system 29, and access terminal 18 includes a transceiver system 30. The transmitter functionality of transceiver system 29 and the receiver functionality of transceiver system 30 will now be explained.

At the transceiver system 29, traffic data for a number of data streams is provided from a data source 31 to a transmit (TX) data processor 32. In one embodiment, each data stream is transmitted over a different transmit antenna. TX data processor 32 formats, codes and interleaves the traffic data for each data stream based on a particular coding scheme selected for that data stream to provide coded data.

For example, the coded data for a data stream may be multiplexed with reference signal data using OFDM techniques. The reference signal data is typically a known data pattern that is processed in a known manner and is used by transceiver system 30 to estimate the channel response. The multiplexed reference signal data and coded data for each data stream are then modulated (i.e., symbol mapped) based on a particular modulation scheme (e.g., BPSK, QSPK, M-PSK, or M-QAM) selected for that data stream to provide modulation symbols. The data rate, coding, and modulation for each data stream is determined by instructions performed by processor 33. The modulation symbols for all data streams are then provided to a TX MIMO processor 34 that further processes the modulation symbols (e.g., for OFDM). TX MIMO processor 34 then provides a number N_{T} of modulation symbol streams to N_{T} transmitters (TMTR) 35A through 35N. In certain embodiments, TX MIMO processor 34 applies beamforming weights to the symbols of the data streams and to the antenna that is transmitting the symbol.

Each transmitter 35 receives and processes a single symbol stream to provide one or more analog signals. In addition, each transmitter 35 further conditions (e.g., amplifies, filters, and upconverts) the analog signals to provide a modulated signal suitable for transmission over the MIMO channel. N_{T} modulated signals from transmitters 35A through 35N are then transmitted from N_{T} antennas 36A through 36N, respectively.

At transceiver system 30, the transmitted modulated signals are received by a number N_{R} of antennas 37A through 37N. The received signal from each antenna 37 is provided to a corresponding receiver (RCVR) 38A through 38N.

In one embodiment, the tasks performed by transceiver system 30 are performed by two separate integrated circuits, an analog radio frequency (RF) transceiver integrated circuit (IC) 39 and a digital baseband IC 40. RF transceiver IC 39 is principally an analog integrated circuit involving analog circuitry, and digital baseband IC 40 is principally a digital integrated circuit that includes digital circuitry. In another embodiment of transceiver system 30 not shown in FIG. 2, both the analog and the digital functions of transceiver system 30 are performed on a single integrated circuit, called a system on a chip (SOC). The system on a chip includes quadrature mixers of the transmit and receive paths, as well as baseband processing and digital control blocks.

Each receiver 38 conditions (e.g., filters, amplifies, and downconverts) the signal it receives. Digital baseband IC 40 digitizes the downconverted signal using a sigma delta analog-to-digital converter 41. A hardware RX data processor 42 receives the digitized signal and generates samples. Then hardware processor 42 further processes the samples to provide a corresponding “received” symbol stream. Thus, hardware processor 42 processes the N_{R} received symbol streams from the N_{R} receivers 38 based on a particular receiver processing technique to provide N_{T} “detected” symbol streams. Hardware processor 42 also demodulates, deinterleaves, and decodes each detected symbol stream to recover the reference signal data or traffic data for the data stream. The processing by hardware RX data processor 42 is complementary to that performed by TX MIMO processor 34 and TX data processor 32 of transceiver system 29.

The reference signal data and traffic data is then processed by a digital signal processor (DSP) 43. In one embodiment, DSP 43 executes a reference signal and handoff management program stored in a memory 44. Memory 44 is a processor-readable medium that in this particular example includes an amount of Static Random Access Memory (SRAM) for the storage of data bit values and variables as well as an amount of Non-Volatile Memory (NVM) or Read Only Memory (ROM) for the storage of a program of processor-executable instructions that are executable by DSP 43. DSP 43 includes at least two sub-processors. In one embodiment, DSP 43 includes a firmware processor 45 and a software processor 46. Firmware processor 45 is adapted to execute a specific instruction set quickly and efficiently. Software processor 46 executes more general instructions, such as those written in C++, but cannot perform specialized functions as quickly as can firmware processor 45. But software processor 46 can be reconfigured more easily than can firmware processor 45. In one implementation, software processor 46 executes an ARM9 instruction set.

The reference signal and handoff management program runs on both firmware processor 45 and software processor 46 and manages the reference signal data, allocates detected reference signals into groups, and performs the handoffs between sectors. A database of system configuration information (also called overhead parameters) from the reference signals, as well as the groupings of sectors characterized by the reference signals, are stored in memory 44. In addition, digital signal processor 43 formulates a reverse link message comprising a matrix index portion and a rank value portion. The reverse link message may include various types of information regarding the communication link and the received data stream. The reverse link message is processed by a TX data processor 47, which also receives traffic data for a number of data streams from a data source 48. The reverse link message is then modulated by a modulator 49, converted to analog by a digital-to-analog converter (DAC) 50, conditioned by transmitters 38A through 38N, and transmitted back to transceiver system 29.

At transceiver system 29, the modulated signals from transceiver system 30 are received by antennas 36, conditioned by receivers 35, demodulated by a demodulator 51, and processed by an RX data processor 52 to extract the reverse link message transmitted by the transceiver system 30. Processor 33 then processes the extracted message and determines which pre-coding matrix to use for determining beamforming weights.

In modern communication systems, there has been an interest in providing interoperability between different communication platforms and systems, such as 3GPP LTE, UMB, WiMax, WiFi and IEEE 802.20. Access points in wireless communication systems that implement different radio technologies, however, may not be synchronous to each other. Even access points belonging to the same communication system may not, in certain instances, be synchronous with each other due to a lack of a common synchronization source. For example, the access points may lack GPS synchronization. In other instances, different access points can service cells and sectors with different sizes, leading to vastly different round-trip transmission times to access terminals. This causes asynchronicity. For example, some access points can be femto access points having cell diameters of a few tens of meters, whereas other access points can be macro access points with cell diameters of a few kilometers. These access points may be configured with different system configuration information, such as different cyclic prefix sizes. An access terminal, such as a mobile handheld device or laptop computer, may detect reference signals from one or more of such access points. The group of reference signals may be time-varying as each device moves from a system using one radio technology to a system using another radio technology or other overhead parameters or system configuration information. Hence, there is a need for the access terminal efficiently to manage such reference signals in order (i) to coordinate the handoff of the access terminal from a serving sector to a desired serving sector, even when one sector is synchronous and the other sector is asynchronous (ii) to make intelligent decisions concerning which reference signals to handoff, (iii) to determine whether to download new overhead information, (iii) and to determine when to send access probes during connected state mode and idle mode. “Connected state mode” refers to a state of an access terminal when the device is actively communicating with an access point. “Idle mode” refers to a state when the access terminal has powered down one or more of its subsystems to save battery life and is no longer in active communication with an access point. An access terminal does, however, receive reference signals while in idle mode.

Consequently, there is a need for a reference signal and handoff management system in access terminals that operate in heterogeneous network environments in which different networks use different radio technologies or the same radio technology but using different overhead parameters, such as the cyclic prefix size or the number Fast Fourier transform (FFT) tones. A reference signal and handoff management system is needed that can efficiently manage and sort reference signals to prevent unnecessary handoffs, overhead downloads, access probes and new registrations. Such a reference signal and handoff management system should be able to handle synchronous and asynchronous systems in idle mode as well as in connected state mode. An alternative to an efficient reference signal and handoff management system would be to employ a brute force method of managing reference signals in which each access terminal acquires information from all reference signals in sectors of which it is in range, including both asynchronous and synchronous sectors. Such a brute force method of managing reference signals, however, would needlessly consume power because the access terminal would indiscriminately acquire unuseful reference signals and perform complex calculations on overhead parameters to obtain results that are not used.

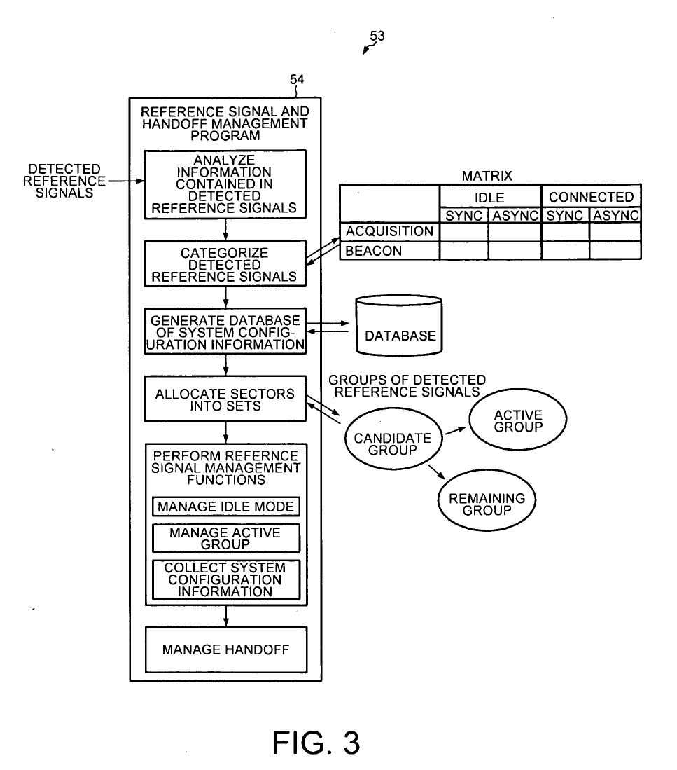

FIG. 3 is a diagram illustrating a general reference signal and handoff management concept 53 implemented on an access terminal. A reference signal and handoff management (RSHM) program 54 stored on access terminal 18 provides management control and assistance for various types of handoff, connection, and related issues of access terminal 18. The RSHM program 54 manages specific details of network configurations, synchronous sectors, asynchronous sectors, and the idle and connected state modes of operation. By using a centralized management program, a single engine in access terminal 18 can be used to assist in the accumulation, dissemination, and control of configuration information used to operate a heterogeneous mobile network. For example, FIG. 3 illustrates the RSHM program 54 configuring the connected modes of synchronous and asynchronous sectors using a matrix of broadband reference signals and narrowband, single-tone reference signals, respectively. The matrix is stored in memory 44. In some radio technologies, the broadband reference signals are referred to as acquisition pilot signals, and the narrowband reference signals are referred to as beacon pilot signals. In other radio technologies, the narrowband reference signals are referred to as power-boosted frequency carriers or power-boosted tones.

Acquisition pilot signals are time-division multiplexed broadband pilot signals transmitted by an access point on a periodic basis to assist the access terminal in obtaining synchronization information. Acquisition pilot signals are sometimes referred to as TDM pilot signals. Acquisition pilot signals are used by the access terminal to accurately synchronize time, frequency and transmission power to an access point. An acquisition pilot signal, however, suffers from the drawback that it places high complexity requirements on the access terminal for simultaneously decoding acquisition pilot signals from different asynchronous sectors. For example, in an OFDMA system, an access terminal may need to instantiate multiple FFT hardware engines in order to decode the acquisition pilot signals from asynchronous systems. Multiple FFT hardware engines may use multiple FFT tones. This is typically prohibitively expensive. For this reason, it is conventionally assumed that access terminals can use acquisition pilot signals only to detect synchronous access points.

Beacon pilot signals are power-boosted narrowband pilot signals transmitted by an access point on a periodic basis to assist the access terminal in obtaining synchronization information. Beacon pilot signals have the advantage that the access terminal can simultaneously detect beacon pilot signals from multiple asynchronous sectors with little increase in complexity. Unfortunately, beacon pilot signals do not provide very accurate time, frequency and power synchronization to an access point. As a result, an access terminal typically uses additional synchronization mechanisms after detecting a beacon pilot signal in order more accurately to synchronize time, frequency and power. For this reason, it is typically assumed that access terminals use beacon pilot signals to detect only synchronous access points.

Although other arrangements may be made according to design implementation, including multiple layers, the matrix of FIG. 3 illustrates a simple segregation of the mobile device operation for these sample modes. In one embodiment, the RSHM program 54 is a software program that contains algorithms for dispatching tasks to manage mobile devices and their respective base stations. An intelligent scheduler is used to manage handoffs and to accumulate and dispense overhead information so as efficiently to assist in minimizing power use and latency.

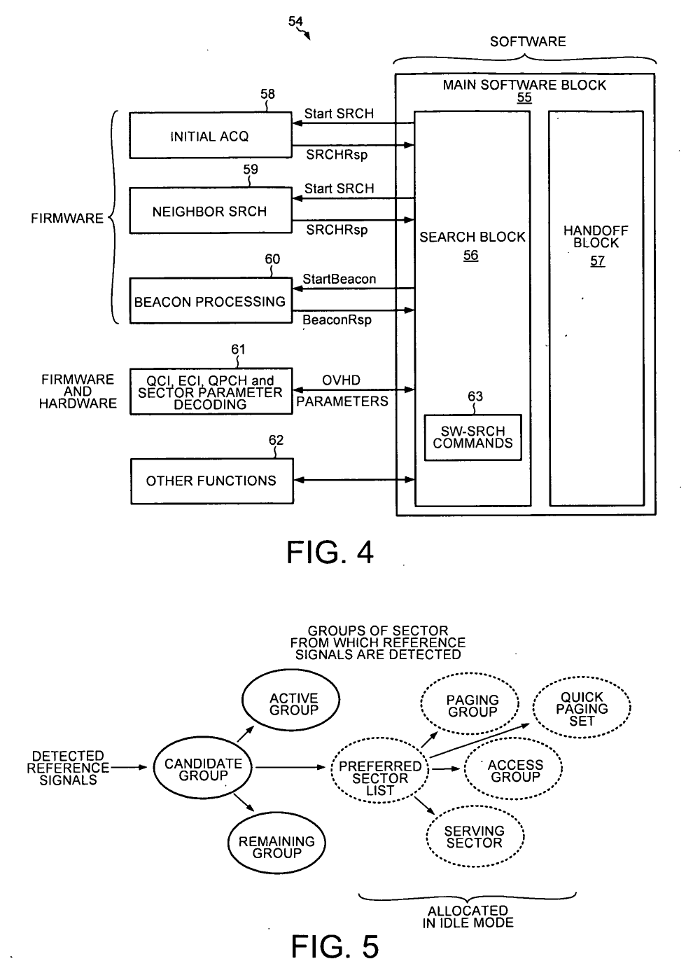

FIG. 4 is a block diagram illustrating software blocks for managing reference signals in one embodiment of RSHM program 54. The software blocks are instructions stored in memory 44 and executed by digital signal processor 43. A main software block 55 is executed by software processor 46 and includes a search block 56 and a handoff block 57. Search block 56 controls tasks relating to reference signal management, and handoff block 57 manages the handoff of access terminal 18. Search block 56 initiates, controls and tabulates sub-blocks of code, such as an initial acquisition block 58, a neighbor search block 59, a beacon processing block 60, an overhead parameter processing block 61, and a block for performing other management functions 62. Initial acquisition block 58 is a block of software that detects and analyzes acquisition pilot signals and that is executed by firmware processor 45. Neighbor search block 59 is a block of software that also detects and analyzes acquisition pilot signals and that is executed by firmware processor 45. Beacon processing block 60 is a block of software that detects and analyzes beacon pilot signals and that is executed by firmware processor 45. Overhead parameter processing block 61 is a block of software that processes overhead parameters using algorithms implemented in hardware, such as hardware processor 42. Overhead parameter processing block 61 is also partly executed by firmware processor 45. Overhead parameter processing block 61 decodes information from access points, such as Quick Channel Information (QCI), Extended Channel Information (ECI), information from Quick Paging Channels (QPCH) and sector parameter information.

Overhead parameter processing block 61 is used to acquire overhead parameters of a new sector. In one example, overhead parameter processing block 61 obtains overhead parameters by performing a sector parameter decode command on pilot signals in a preferred pilot list when certain conditions exist. The conditions include (i) that a sector parameter is unknown, (ii) that a supervision timer (also called a drop timer) equals zero, or (iii) that the relative energy (also call the geometry) of the new sector is greater than a predetermined sector parameter decode threshold. Overhead parameter processing block 61 also acquires overhead parameters of a new sector by issuing an ECI decode command on pilot signals in the preferred pilot list when certain conditions exist. The conditions include (i) that quick channel information and extended channel information are unknown, (ii) that the validity of known quick channel information and known extended channel information has expired, and QPCH decoding has failed once, (iii) that a supervision timer equals zero, or (iv) that a relative energy of the new sector is greater than a predetermined ECI decode threshold.

Overhead parameter processing block 61 also verifies overhead (OVHD) parameters of a new sector by performing QPCH decoding on pilot signals under certain conditions, such as (i) the validity of a known OVHD parameter of a regular access terminal having expired, (ii) the validity of a known OVHD parameter of a push-to-talk access terminal expiring shortly, or (iii) a pilot signal received by the push-to-talk access terminal being in the access group.

Other reference signal and handoff management tasks are also implemented by block 62 according to design preference. Search block 56 also allocates the various sectors from which pilot signals are received into groups both during connected state mode and idle mode of access terminal 18.

Search block 56 also manages the tasks that determine the pilot energy of pilot signals and that calculate the geometry of sectors or access points. The geometry of both synchronous and asynchronous sectors and access points are calculated. The pilot energy of a pilot signal is measured in dBm. The geometry of a sector or access point is the ratio of the pilot energy of a pilot signal from that sector or access point to the pilot energies of other pilot signals from other sectors or access points. The geometry of a sector or access point A can be derived as: geometry (A)=(pilot energy (A))/(pilot energy (A)+pilot energy (B)+pilot energy (C)+ . . . pilot energy (N)), where A, B, C . . . N are the sectors or access points for which pilot energy information is available at the access terminal. Search block 56 performs overhead management in a very efficient manner, resulting in less battery use and faster response times for the access terminal.

In one of several possible embodiments, software search (SW SRCH) commands 63 executed by search block 56 generate a database of overhead parameters from pilot signals detected from each access point or sector. Search block 56 builds the database using the functions performed by blocks 58-60 on firmware processor 45, such as the search response (SearchResponse or SRCHRsp) and beacon response (BeaconResponse or BeaconRsp) functions. The database of overhead parameters is stored in memory 44. Some of the overhead parameters of the database include: PilotEnergyTDM, AvgPilotEnergyTDM, PilotEnergyBeacon, AvgPilotEnergyBeacon, CPLength, SyncToServingSectorBit, Geometry, DropTimer and TimingOffset.

The PilotEnergyTDM parameter is obtained from acquisition pilot signals and is calculated by algorithms in the SRCHRsp function. The AvgPilotEnergyTDM parameter also relates to acquisition pilot signals and is obtained by IIR filtering of the PilotEnergyTDM parameter, for example, using 100 msec averaging. The PilotEnergyBeacon is obtained from beacon pilot signals and calculated using algorithms in the BeaconRsp function. The AvgPilotEnergyBeacon parameter also relates to beacon pilot signals and is obtained by IIR filtering of the PilotEnergyBeacon parameter, for example, using 200 msec averaging. The CPLength parameter indicates the cyclic prefix length of the delay spread that access terminals in the associated sector can tolerate. The SyncToServingSectorBit parameter indicates whether the serving sector is synchronous or asynchronous. In one embodiment, setting the bit to 1 or 0 indicates that the serving sector is synchronous or asynchronous, respectively. The geometry parameter indicates the ratio of pilot energy of one pilot signal to the energies of all detected pilot signals. The DropTimer parameter is invoked when a PilotEnergy parameter exceeds a certain threshold or duration. Thus, the DropTimer parameter is used to track the period in which the pilot energy is below the threshold or duration. The TimingOffset parameter indicates the offset relative to the serving sector. Other overhead parameters in the database include the number of antennas in the serving sector, which FFT tones are used for Fourier transform calculations, the number of frames or time slots in a superframe and the number of OFDM symbols in a frame.

In the connected state mode, a pilot signal is considered to be synchronous to the serving sector if its pilot energy is detected by the SRCHRsp function associated with the serving sector. In one implementation, the geometry of a given sector A is calculated as Geometry (A)=(pilot energy (A))/(pilot energy (A)+pilot energy (B)+pilot energy (C)+ . . . pilot energy (N)), where the pilot energy refers to the AvgPilotEnergyTDM parameter for those sectors with the SyncToServingSectorBit parameter being synchronous, and the pilot energy being the AvgPilotEnergyBeacon parameter for those sectors with the SyncToServingSectorBit parameter being asynchronous.

In order to maintain current overhead parameters during handoff, the SyncToServingSectorBit parameter should be updated for each sector. Using geometry calculations it is possible to assess the energy level arising from different sectors that are within range or nearly within range of the access terminal.

In the connected state mode, the software search (SW SRCH) commands 63 executed by search block 56 further classify the sectors from which pilot signals are detected into multiple groups, such as CandidateSet, RemainingSet and ActiveSet (ASET). Each sector from which a pilot signal is newly detected is first added to the CandidateSet if the pilot signal meets minimum energy criteria for a certain duration of time. Sectors in the CandidateSet are either promoted to the ActiveSet or demoted to the RemainingSet based upon additional criteria. Most of the overhead collection and handoff operations are restricted to the sectors in the ActiveSet, as opposed to being performed on all sectors from which pilot signals are detected. Performing operations only on pilot signals from the ActiveSet of sectors limits the computations that must be performed by the access terminal and hence prolongs battery life. Sample criteria for classifying sectors into one of the three groups CandidateSet, RemainingSet and ActiveSet are described below.

A sector is added to the CandidateSet based on the geometry parameter of its pilot signal exceeding a certain threshold, called the AddThreshold. A sector is deleted from the ActiveSet if its DropTimer parameter falls below a PilotDropTimer parameter. A sector is removed from the CandidateSet if its DropTimer parameter is greater than or equal to the PilotDropTimer parameter. Where a sector is deleted from the Candidate Set, the sector is moved to the RemainingSet without changing the DropTimer parameter for the sector. If adding a sector to the CandidateSet would result in the maximum size of the CandidateSet being exceeded, software search (SW SRCH) commands 63 delete the sector with the weakest pilot signal from the CandidateSet.

A sector is added to the RemainingSet if the sector is deleted from the CandidateSet or the ActiveSet. A given sector is deleted from the RemainingSet in two situations. First, the sector is deleted if the DropTimer parameter of the given sector is greater than or equal to the PilotDropTimerRemainingSet parameter. Second, the sector is deleted if (i) another sector is added to the RemainingSet, (ii) the size of the RemainingSet exceeds its threshold (MaxRemainingSetSize), and (iii) the given sector has the weakest pilot signal.

The ActiveSet is configured when the access terminal constructs a PilotReport message. The access point is periodically updated with this PilotReport message. The serving access point uses the PilotReport message to add each new sector and access point to the ActiveSet. The access point “tunnels” the overhead parameters of the newly added sector to the access terminal. “Tunneling” is a process whereby the serving access point A communicates with another access point B using a wired or wireless link to obtain all of the overhead parameters of access point B and then transmits those overhead parameters to the access terminal using the serving sector communication link.

FIG. 5 is a diagram illustrating how RSHM program 54 allocates sectors from which pilot signals are detected into groups and subgroups. In the idle mode (sleep state), the software search commands 63 within search block 56 further classify sectors into multiple groups, such as PreferredSectorList, PagingSet, AccessSet, and ServingSector. Each sector from which a pilot signal is newly detected is first added to the CandidateSet provided the newly detected pilot signal meets the minimum energy criteria for a predetermined duration of time. Only sectors in the CandidateSet are then promoted to one of the PreferredSectorList, PagingSet, AccessSet or ServingSector based upon additional criteria described below. This is done so that time and power intensive operations are restricted to a smaller subgroup of sectors, rather than being performed on pilot signals from the entire collection of sectors. For example, access terminal 18 sends an access probe only to sectors associated with pilot signals in the AccessSet because transmitting an access probe is very power intensive for an access terminal in idle mode. In another example, access terminal 18 monitors only pages in pilot signals from sectors belonging to the PagingSet. This improves the probability that a page will be successfully detected and consequently reduces power consumption and prolongs battery life. Power is also saved by receiving and transmitting data packets only from and to sectors associated with pilot signals in the ServingSector.

Sectors from which pilot signals are detected are allocated to the PreferredSectorList (PSL) as follows. A sector is added to the PreferredSectorList if the geometry parameter of its pilot signal exceeds the AddThreshold. If the geometry parameter of the pilot signal falls below the DropThreshold, then a timer that generates the DropTimer parameter is invoked. The sector for which the pilot signal is detected is then dropped from the PreferredSectorList if the DropTimer parameter becomes greater than or equal to the maximum {SleepPeriod*NumSleepCycles, DropTimerMin} in msec. In addition, the sector is dropped from the PreferredSectorList if the size of the PreferredSectorList exceeds a threshold.

Sectors from the PreferredSectorList are added to the PagingSet if the sector parameter information in the detected pilot signal has been decoded, and search block 56 determines that the sector corresponding to the pilot signal is sending pages to the access terminal. A sector in PagingSet is deleted if the sector has been deleted from the PreferredSectorList. The sectors in the PagingSet are sorted based on registration status and also by the geometry of their pilot signals.

Sectors in the PreferredSectorList are added to the AccessSet if all overhead parameters for the sector in the pilot signal have been successfully decoded and validated. The sectors in the AccessSet are sorted based on the geometry of their pilot signals. A sector in the AccessSet is deleted if the sector has been deleted from the PreferredSectorList.

The sector in the PreferredSectorList with the strongest pilot signal and for which all overhead parameters have been decoded is the ServingSector. To save battery life, the ServingSector is confined to access points for which the access terminal already has registration information, unless the geometry of a newly detected pilot signal in another registration zone is significantly better than the pilot signals in the current registration zone. For example, for a new sector in a different registration zone to replace the existing ServingSector, the geometry of the pilot signal from the new sector must exceed the sum of the geometry of the pilot signal from the ServingSector plus the IdleHandoffHysteresisMargin. The idle hand-off hysteresis margin is added to prevent unnecessary registration operations that are very time and power intensive.

The subgroups of sectors described above are only a list of some convenient categories used by a preferred reference signal and handoff management program. In some instances, it is desirable to reduce the number of subgroups or to increase the number of subgroups. Therefore, other groups or subgroups of sectors may be used according to design preference.

The RSHM program 54 performs idle-mode call flow in several scenarios. One scenario is based on when an access terminal wakes up during paging cycles. The access terminal monitors QuickPages and/or pages every paging cycle from the access points and sectors of the PagingSet. The access terminal typically decodes QuickPages first due to lower terminal computation complexity. Some radio technologies use a quick paging channel (QPCH) in addition to a paging channel to extend standby time. The paging channel and the quick paging channel are distinct code channels. QuickPage pilot signals are transmitted on the QPCH. The quick paging channel includes quick paging bits that are set to indicate a page in the general paging message of the paging channel. If both quick paging bits in the quick paging channel are not set, the access terminal need not demodulate the subsequent general paging message in the general paging channel. Less energy is consumed demodulating the quick paging bits than demodulating the relatively longer general paging message. By demodulating the quick paging bits of the quick paging channel, the general paging message in the paging channel can be demodulated only when there is a page. The access terminal must correctly decode the QPCH to determine whether the access terminal has been paged.

After a QuickPage is successfully decoded, but where there is no valid page to the access terminal, the access terminal sleeps until the next paging cycle. Otherwise, the access terminal decodes a full page on the first pilot signal of the PagingSet if all QPCH decoding fails or upon the successful decoding of a QPCH with a valid page. In a deployment with asynchronous sectors or access points, on every paging cycle the access terminal also decodes beacon pilot signals that correspond to other asynchronous access points or sectors. If beacon processing block 60 executing on firmware processor 45 reports a valid full page, the access terminal sends access probes to the sector of the AccessSet with the strongest pilot signal. In idle mode, the access terminal monitors and decodes overhead channels for pilot signals from sectors in the PreferredSectorList based upon predetermined rules, such as (i) if the overhead information is unknown, (ii) the DropTimer equals zero, or (iii) the geometry of a pilot signal is greater than the OverheadDecodeThreshold.

For example, when access terminal 18 wakes up during a paging cycle to decode a QuickPage, RSHM program 54 initiates an acquisition pilot signal search (Start SRCH function) for a sector that has already been allocated to the preferred sector list. RSHM program 54 decodes the pilot signal received from the sector in the preferred sector list. Then if the QuickPage is successfully decoded, RSHM program 54 waits for the next superframe to perform an additional pilot signal search function. If the QuickPage is not successfully decoded, access terminal 18 goes back to sleep.

Push-To-Talk (PTT) access terminals initiate calls in a very short time period. Hence, PTT access terminals do not expend time to collect overhead parameters from scratch when the access terminal initiates a call. As a result, even in idle mode, PTT access terminals monitor and decode overhead parameters with higher frequency in order to prevent having outdated overhead information. In one embodiment, the access terminal monitors and decodes the QPCH channel in order to ensure that overhead parameters are up-to-date. A failure to decode the QPCH channel may indicate that the overhead parameters are outdated. Thus, when QPCH channel decoding fails, the PTT access terminal decodes overhead channels and updates its overhead information.

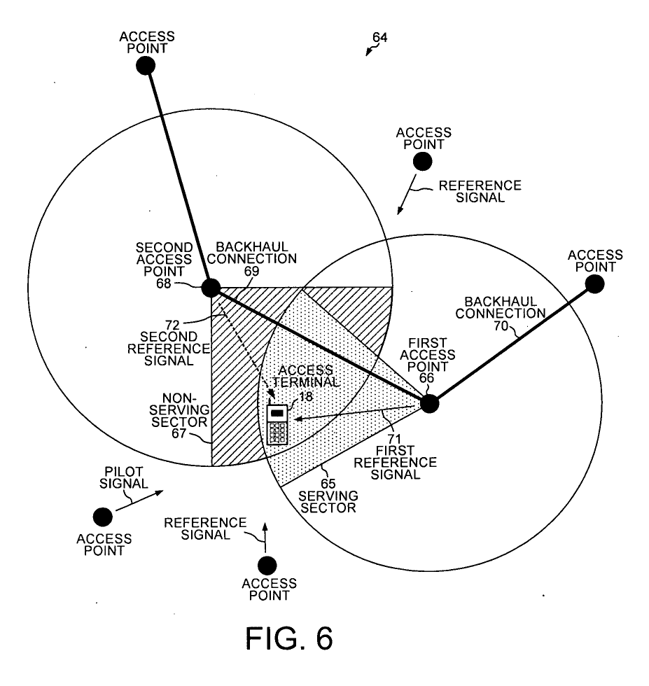

FIG. 6 illustrates an exemplary heterogeneous network topology 64 in which RSHM program 54 operates. Access terminal 18 borders on two sectors. A first sector 65 is covered by a first access point 66. A second sector 67 is covered by a second access point 68. First sector 65 is a serving sector because access terminal 18 is actively communicating with sector 65. Second sector 67 is a non-serving sector because the user of access terminal 18 is not actively sending or receiving voice or data traffic to or from second sector 67. RSHM program 54 is resident on access terminal 18. First access point 66 is connected to second access point 68 by a backhaul connection 69. First access point 66 is also connected to another access point by a backhaul connection 70.

In one example, first access point 66 implements the 3GPP LTE radio technology. Thus, serving sector 65 is a synchronous sector. Second access point 68 implements the IEEE 802.11 radio technology, and non-serving sector 67 is an asynchronous sector. RSHM program 54 efficiently manages the handoff between heterogeneous networks. First access point 66 transmits a first reference signal 71, and second access point 68 transmits a second reference signal 72. In this heterogeneous network topology, there are also other networks that implement different radio technologies. Thus, access points from networks implementing multiple radio technologies are transmitting reference signals that reach access terminal 18. In addition, access terminal 18 is receiving reference signals from access points implementing the same radio technology as first access point 66, but those other access points may be heterogeneous because they employ other operating parameters, such as cyclic prefix sizes and FFT tones.

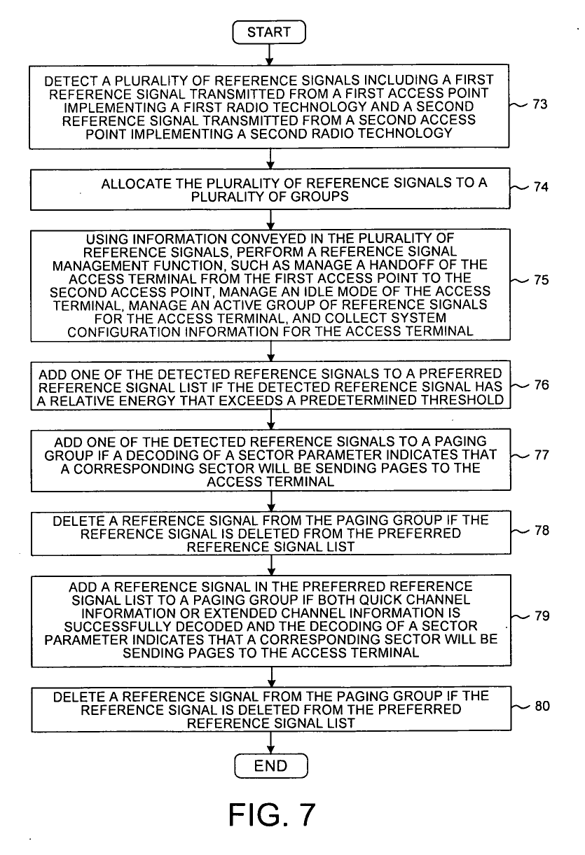

FIG. 7 is a flowchart illustrating steps 73-80 of a method by which RSHM program 54 manages reference signals and uses information conveyed in those reference signals to perform functions for access terminal 18. The steps of FIG. 7 will now be described in relation to the exemplary heterogeneous network topology 64 shown in FIG. 6.

In a first step 73, RSHM program 54 detects multiple reference signals, including first reference signal 71, second reference signal 72 and the reference signals transmitted by the other heterogeneous access points. First reference signal 71 is transmitted from first access point 66 that implements a first radio technology, namely 3GPP LTE. Second reference signal 72 is transmitted from second access point 68 that implements a second radio technology, namely IEEE 802.11. In this example, 3GPP LTE and IEEE 802.11 are different radio technologies. In other exemplary topologies, even where both the first and second access points implement one type of radio technology, the radio technologies implemented by both access points might not be identical if the two access points use different frequencies, timing or other different operating parameters.

In a step 74, the software search commands 63 within search block 56 allocate the multiple sectors into multiple groups, such as a candidate group, a remaining group, an active group, a preferred sector list, a paging group, a quick paging set, an access group, and a serving sector.

In a step 75, RSHM program 54 performs a reference signal management function using information conveyed in the detected reference signals. For example, the reference signal management function can be (i) to manage the idle mode of access terminal 18, (ii) to manage the active group of reference signals for access terminal 18, and (iv) to collect overhead parameters for access terminal 18.

In order to perform reference signal management functions efficiently, RSHM program 54 updates which sectors are in each of the groups. In a step 76, software search commands 63 add one of the sectors from which a detected reference signal is detected to the preferred sector list if the detected reference signal has a geometry that exceeds a predetermined threshold. In a step 77, software search commands 63 add one of the sectors to the paging group if the decoding of a sector parameter indicates that the sector will be sending pages to access terminal 18. For example, software search commands 63 add non-serving sector 67 to the paging group if the decoding of a sector parameter from second reference signal 72 indicates that sector 67 will be sending pages to access terminal 18. In a step 78, software search commands 63 deletes a sector from the paging group if the sector is deleted from the preferred sector list. In a step 79, software search commands 63 add a sector from the preferred sector list to the quick paging set if both (i) quick channel information (QCI) or extended channel information (ECI) for the sector is successfully decoded and (ii) the decoding of a sector parameter indicates that the sector will be sending pages to access terminal 18. In a step 80, software search commands 63 delete a sector from the quick paging set if that sector is deleted from the preferred sector list.

In another step, software search commands 63 configure the active group. The active group is configured when access terminal 18 sends a PilotReport message to first access point 66. The serving access point 66 uses the PilotReport message to add new sectors and access points to the active group. Non-serving sector 67 is added to the active group. Access point 66 tunnels the overhead parameters of the newly added sector 67 to access terminal 18 by receiving those parameters from second access point 68 over backhaul connection 69 and then transmitting those parameters to access terminal 18 using the communication link of serving sector 65.

It is understood that the specific order or hierarchy of steps in the method of FIG. 7 is an exemplary approaches. Based upon design preferences, it is understood that the specific order or hierarchy of steps in the method may be rearranged while remaining within the scope of the present disclosure. The accompanying method claims present elements of the various steps in a sample order, and are not meant to be limited to the specific order or hierarchy presented.

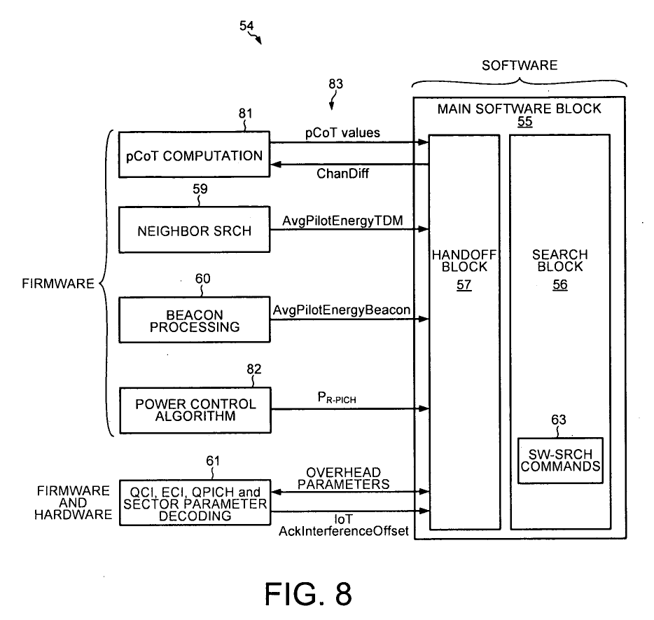

FIG. 8 is a block diagram illustrating software blocks of another embodiment of RSHM program 54 in which RSHM program 54 efficiently manages the handoff between sectors that are not necessarily synchronous with one another sectors. As with the embodiment of FIG. 4, the software blocks of FIG. 8 are instructions stored in memory 44 and executed by digital signal processor 43. Handoff block 57 manages the handoff of access terminal 18. Handoff block 57 polls and receives data from firmware modules that are executed by firmware processor 45. Handoff block 57 processes the polled and received information 83 and uses the processed information for handoff control and management.

Handoff block 57 initiates, controls and tabulates the sub-blocks of code located in a pCoT computation block 81, a power control algorithm block 82, neighbor search block 59, beacon processing block 60, and overhead parameter processing block 61. Handoff block 57 makes handoff decisions for both the forward and reverse links, as well as performs associated overhead management in a very efficient manner, resulting in less battery use and faster response times for the access terminal. Handoff block 57 enables handoff to be efficiently made to both a synchronous and an asynchronous desired serving sector by evaluating both reverse link (RL) and forward link (FL) constraints, such as channel quality and link budgets. In addition, handoff block 57 applies varying weighting factors between the RL and FL constrains to determine which sector is suitable for handoff negotiation.

Handoff block 57 determines the appropriate sector for handoff based on various overhead parameters, such as the channel quality indicator pCoT (power of carrier over thermal), ChanDiff (channel difference), AvgPilotEnergyTDM, AvgPilotEnergyBeacon, the link budget as indicated by the power spectral density of the reverse link broadband pilot channel (P_{R-PICH}), and the interference over thermal ratio (IoT) or rise over thermal ratio (RoT). The interference over thermal noise ratio is used for OFDMA and SC-FDMA systems, whereas the rise over thermal noise ratio is used in CDMA systems.

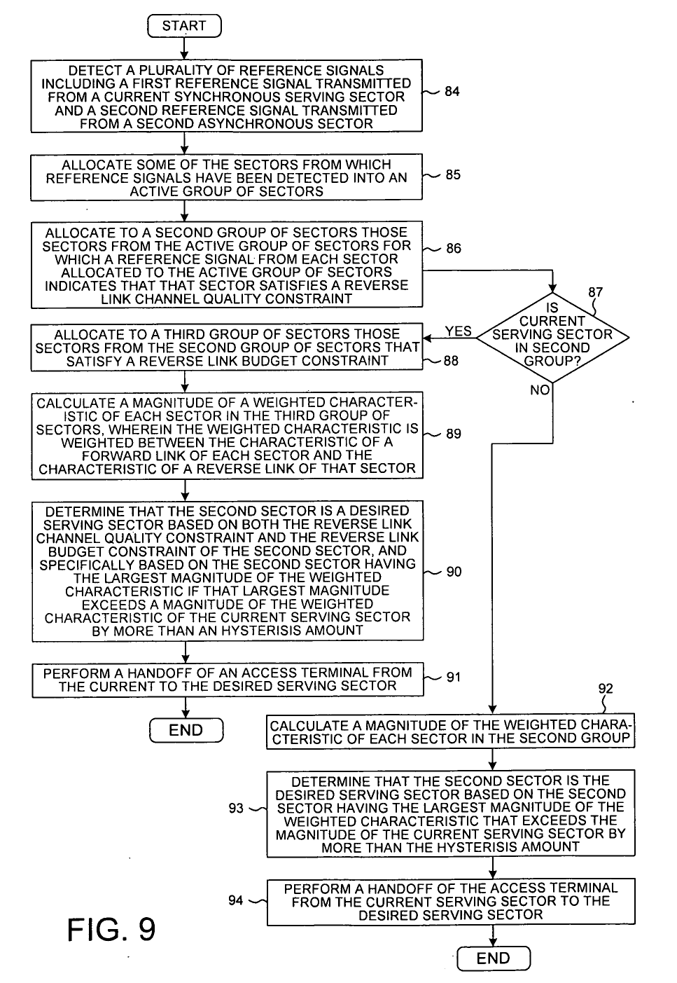

FIG. 9 is a flowchart illustrating steps 84-93 of a method by which RSHM program 54 manages reference signals and uses information conveyed in those reference signals to designate a desired serving sector and to perform the handoff of access terminal 18 from the current serving sector to the desired serving sector. The steps of FIG. 9 will now be described in relation to the exemplary heterogeneous network topology 64 shown in FIG. 6.

In a first step 84, RSHM program 54 detects multiple reference signals, including first reference signal 71, second reference signal 72 and the reference signals transmitted by the other heterogeneous access points. First reference signal 71 is transmitted from current serving sector 65 that implements a first radio technology, namely 3GPP LTE. Second reference signal 72 is transmitted from second sector 67 that implements a second radio technology, namely IEEE 802.11. In this example, current serving sector 65 and second sector 67 implement different radio technologies. In other exemplary topologies, even where both the current serving sector and the second serving sector implement the same type of radio technology, the radio technologies implemented by both sectors might not be identical if the two sectors use different frequencies, timing or other different operating parameters. In this example, current serving sector 65 and second sector 67 are asynchronous to one another.

In a step 85, the software search commands 63 within search block 56 allocate some of the sectors from which reference signals have been detected into a first group of sectors, such as the active group of sectors.

In a step 86, handoff block 57 allocates to a second group of sectors those sectors from the active group of sectors for which a reference signal from each sector allocated to the active group of sectors indicates that the sector satisfies a reverse link channel quality constraint. In order to determine channel quality, access terminal 18 monitors the forward link PQI channel (F-PQICH) of each sector to which it is transmitting a reverse link broadband pilot channel (R-PICH). Handoff block 57 receives the pilot quality indicator (PQI) from overhead parameter processing block 61 for each sector from which access terminal 18 detects a F-PQICH. pCoT computation block 81 uses the pilot quality indicator (PQI) to calculate the pCoT. For each reverse link to a sector and for each forward link from a sector, handoff block 57 provides channel difference (ChanDiff) value to pCoT computation block 81. ChanDiff is the difference in channel gains of the prospective desired serving sector compared to the gain of the reverse link serving sector. Block 81 then computes and provides to handoff block 57 the pCoT value for the reverse link and forward link for each sector, which are used to determine whether each sector satisfies the reverse link channel quality constraint and the forward link channel quality constraint. The pCoT of a prospective desired serving sector can be expressed as a function of the pCoT of the reverse link of the current serving sector and the channel difference of the prospective serving sector, as follows:

pCoT_{DSS}=pCoT_{RLSS}−ChanDiff_{DISS}.

In a step 87, handoff block 57 determines whether current serving sector 65 is a member of the second group of sectors that was chosen by handoff block 57 in step 86. If current serving sector 65 belongs to the second group of sectors, handoff block 57 proceeds to a step 88. If current serving sector 65 does not belong to the second group of sectors, handoff block 57 proceeds to a step 92.

In step 88, handoff block 57 allocates to a third group of sectors those sectors from the second group of sectors that satisfy a reverse link budget constraint. For each member of the second group of sectors, power control algorithm block 82 determines the power spectral density of the reverse link broadband pilot channel (P_{R-PICH}) and provides that value to handoff block 57. Handoff block 57 then uses the reverse link broadband pilot channel (P_{R-PICH}) to determine the power spectral density of the reverse link acknowledgement channel in support of the forward link H-ARQ (P_{R-ACKCH}). Finally, handoff block 57 determines the link budget constraint for the reverse link to the desired serving sector by calculating the power required for the reverse link acknowledgement channel (R-ACKCH).

In a step 89, handoff block 57 calculates the magnitude of a weighted characteristic of each sector in the third group of sectors. The weighted characteristic is weighted between the characteristic for the forward link from each sector and the characteristic for the reverse link to that sector.

In one embodiment, the characteristic is channel quality and is measured using different parameters for the forward link and the reverse link. For the forward link, the channel quality characteristic is measured using an energy parameter. The characteristic for the forward link is based on the difference between an energy parameter of second reference signal 72 and that energy parameter of first reference signal 71. For handoffs between synchronous sectors, for each forward link from a sector in the third group of sectors, neighbor search block 59 calculates the average TDM pilot energy (AvgPilotEnergyTDM). The AvgPilotEnergyTDM parameter relates to acquisition reference signals and is obtained by IIR filtering a PilotEnergyTDM parameter. Neighbor search block 59 provides the values of the AvgPilotEnergyTDM parameter to handoff block 57. For handoffs between asynchronous sectors, for each forward link from a sector in the third group of sectors, beacon processing block 60 calculates the average beacon pilot energy (AvgPilotEnergyBeacon). The AvgPilotEnergyBeacon parameter relates to beacon pilot signals and is obtained by IIR filtering a PilotEnergyBeacon parameter. Beacon processing block 60 provides the values of the AvgPilotEnergyBeacon parameter to handoff block 57. Handoff block 57 then uses the AvgPilotEnergyTDM and AvgPilotEnergyBeacon values to calculate the magnitude of the

The characteristic for the reverse link is the difference between a channel quality parameter of second reference signal 72 minus that channel quality parameter of first reference signal 71. For handoffs between synchronous as well as asynchronous sectors, for each reverse link to a sector in the third group of sectors, handoff block 57 uses the pCoT channel quality value provided by pCoT computation block 81 to calculate the magnitude of the characteristic for the reverse link to each prospective desired serving sector. Handoff block 57 then applies varying weightings for the forward and reverse links to calculate the magnitude of the weighted characteristic for of each sector in the third group of sectors.

In a step 90, handoff block 57 determines that second sector 67 is the desired serving sector based on (i) second sector 67 belonging to the third group of sectors, and (ii) second sector 67 having the largest magnitude of the weighted characteristic, but only if that largest magnitude exceeds the magnitude of the weighted characteristic of current serving sector 65 by more than an hysteresis amount. Because the determination of whether second sector 67 belongs to the third group of sectors and has the largest weighted characteristic is based on pCoT channel quality values, AvgPilotEnergyTDM values, AvgPilotEnergyBeacon values and the power spectral density of the reverse link broadband pilot channel (P_{R-PICH}) for second sector 67, the determination that second sector 67 is the desired serving sector is based on both a reverse link channel quality constraint and on a reverse link budget constraint of second sector 67. If the sector of the third group of sectors with the largest magnitude of the weighted characteristic, such as second sector 67, does not have a magnitude of the weighted characteristic that exceeds the magnitude of the weighted characteristic of current serving sector 65 by more than the hysteresis amount, the desired serving sector is determined to remain the current serving sector 65.

In a step 91, handoff block 57 of RSHM program 54 performs the handoff of access terminal 18 from current serving sector 65 to second sector 67.

If in step 87, handoff block 57 determines that current serving sector 65 does not belong to the second group of sectors, handoff block 57 proceeds to step 92. In step 92, handoff block 57 calculates the magnitude of a weighted characteristic of each sector in the second group of sectors. As in step 89, the weighted characteristic is weighted between the characteristic for the forward link from each sector and the characteristic for the reverse link to that sector. The characteristic for the forward link is based on the difference between an energy parameter of second reference signal 72 and that energy parameter of first reference signal 71. For handoffs between asynchronous sectors, for each forward link from a sector in the second group of sectors, handoff block 57 uses AvgPilotEnergyTDM values, AvgPilotEnergyBeacon values, and an asynchronous handoff margin to calculate the magnitude of the characteristic. For handoffs between synchronous sectors, for each forward link from a sector in the second group of sectors, handoff block 57 uses only AvgPilotEnergyTDM values and a synchronous handoff margin to calculate the magnitude of the characteristic. The characteristic for the reverse link is the difference between a channel quality parameter of second reference signal 72 minus that channel quality parameter of first reference signal 71. For handoffs between both synchronous and asynchronous sectors, for each sector in the second group of sectors, handoff block 57 uses the pCoT channel quality value to calculate the magnitude of the characteristic. Handoff block 57 then applies varying weightings for the forward and reverse links to calculate the magnitude of the weighted characteristic for of each sector in the second group of sectors.

In a step 93, handoff block 57 determines that second sector 67 is the desired serving sector based on (i) second sector 67 belonging to the second group of sectors, and (ii) second sector 67 having the largest magnitude of the weighted characteristic, but only if that largest magnitude exceeds the magnitude of the weighted characteristic of current serving sector 65 by more than the hysteresis amount. If the sector of the second group of sectors with the largest magnitude of the weighted characteristic, such as second sector 67, does not have a magnitude of the weighted characteristic that exceeds the magnitude of the weighted characteristic of current serving sector 65 by more than the hysteresis amount, the desired serving sector is determined to remain the current serving sector 65.

In a step 94, handoff block 57 of RSHM program 54 performs the handoff of access terminal 18 from current serving sector 65 to second sector 67.

In one embodiment, RSHM program 54 is implemented in network configurations in which the same sector is both the forward link serving sector and the reverse link serving sector. Thus, in this embodiment, there are no disjoint links. An example of a network configuration in which the same sector is both the forward link serving sector and the reverse link serving sector is shown in FIG. 1. In the absence of disjoint links, the channel quality values for the forward link and the reverse link are assumed to be the same. In this embodiment, the sectors that are allocated to the second group of sectors in step 86 can be identified by analyzing only the reverse link channel quality and assuming that the forward link channel quality is the same. Thus, a prospective desired serving sector is allocated to the second group in step 86 if both (i) the maximum pCoT (pCoT_{Max}) minus the pCoT of the prospective desired serving sector (pCoT_{DRLSS}) is less than a predetermined maximum reverse link pilot channel quality difference for the desired serving sector (MaxRLPilotDifferenceForDRLSS), and (ii) the maximum pCoT (pCoT_{Max}) minus the pCoT of the current serving sector (pCoT_{RLSS}) is less than a predetermined maximum reverse link pilot channel quality difference for the current serving sector (MaxRLPilotDifferenceForRLSS). In this embodiment, the channel quality constraints are established by setting MaxRLPilotDifferenceForDRLSS equal to 2 dB and MaxRLPilotDifferenceForRLSS equal to 3 dB.

In another embodiment, RSHM program 54 is implemented in network configurations with disjoint links. Where there are disjoint links, the channel quality values for the forward link and the reverse link are determined separately. In this embodiment, the sectors that are allocated to the second group of sectors in step 86 are identified by analyzing both the reverse link channel quality and the forward link channel quality. Thus, a prospective desired serving sector is allocated to the second group in step 86 if four constraints are satisfied: (i) pCoT_{Max} minus pCoT_{DRLSS} for the reverse link is less than the predetermined MaxRLPilotDifferenceForDRLSS, (ii) pCoT_{Max} minus pCoT_{RLSS} for the reverse link is less than the predetermined MaxRLPilotDifferenceForRLSS, (iii) pCoT_{Max} minus the pCoT for the forward link from the prospective desired serving sector (pCoT_{DFLSS}) is less than a predetermined maximum forward link pilot channel quality difference for the desired serving sector (MaxRLPilotDifferenceForDFLSS), and (iv) pCoT_{Max} minus the pCoT for the forward link from the current serving sector (pCoT_{FLSS}) is less than a predetermined maximum forward link pilot channel quality difference for the current serving sector (MaxRLPilotDifferenceForFLSS). In this embodiment, the channel quality constraints are established by setting MaxRLPilotDifferenceForDFLSS equal to 4 dB, MaxRLPilotDifferenceForFLSS equal to 6 dB, MaxRLPilotDifferenceForDRLSS equal to 1 dB and MaxRLPilotDifferenceForRLSS equal to 3 dB. The channel quality constrains for this embodiment can be expressed as:

DFLSS: pCoT_{Max}−pCoT_{DFLSS}<MaxRLPilotDifferenceForDFLSS

FLSS: pCoT_{Max}−pCoT_{FLSS}<MaxRLPilotDifferenceForFLSS

DRLSS: pCoT_{Max}−pCoT_{DRLSS}<MaxRLPilotDifferenceForDRLSS

RLSS: pCoT_{Max}−pCoT_{RLSS}<MaxRLPilotDifferenceForRLSS

The predetermined values of the constraints described above for both embodiments may be adjusted according to design implementation. Therefore, changes may be made without departing from the spirit and scope of the disclosed RSHM program 54.

The constraints applied in step 88 to the link budget identify sectors based on the power required to transmit control channels over the reverse link back to each prospective desired serving sector. In one embodiment, the link budget is defined as the total power required to transmit the reverse link acknowledgement channel (R-ACKCH). The total power required to transmit the R-ACKCH must be less than the maximum power of access terminal 18. Handoff block 57 determines the total power required to transmit the R-ACKCH to each prospective desired serving sector by using various overhead parameters, such as the power spectral density of the reverse link pilot channel (P_{R-PICH}), the pCoT of the desired serving sector, the slow interference offset value of the desired serving sector (SlowInterferenceOffset_{DSS}), the acknowledgement channel interference offset value of the desired serving sector (ACKInterferenceOffset_{DSS}) and the acknowledgement channel target carrier-to-interference ratio (ACKTargetCtoI).

First, handoff block 57 obtains the aforementioned overhead parameters from firmware blocks 59-60 and 81-82 and overhead parameter processing block 61. Then, handoff block 57 calculates the power spectral density of the reverse link acknowledgement channel to the prospective desired serving sector (P_{R-ACKCH, DSS}). The power spectral density P_{R-ACKCH, DSS} can be expressed as:

P_{ACKCH,DSS}=P_{PICH}−pCoT_{DSS}+SlowinterferenceOffset_{DSS}+ACKInterferenceOffset_{DSS}+ACKTargetCtoI.

Handoff block 57 then calculates the power required to transmit the reverse link acknowledgement channel to the prospective desired serving sector using the power spectral density of the R-ACKCH and the bandwidth of the R-ACKCH. The power required to transmit the reverse link acknowledgement channel to the prospective desired serving sector is expressed as:

Power_{ACKCH, DSS}=P_{ACKCH, DSS}+10*log10(BW_{ACKCH}),

where BW_{ACKCH} is the bandwidth of the R-ACKCH. In one network configuration, for example, the bandwidth of the R-ACKCH is eight times 9.6 KHz, corresponding to eight time slots of 9.6 KHz each. The prospective desired serving sector is designated to be the desired serving sector only if the maximum power of access terminal 18 is greater than or equal to the power required to transmit the reverse link acknowledgement channel (Power_{ACKCH, DSS}). If access terminal 18 does not have sufficient power to transmit R-ACKCH, then access terminal 18 cannot acknowledge forward link control signals from the prospective desired serving sector.

In steps 89 and 92, handoff block 57 calculates the magnitudes of a channel quality characteristic for both the forward link and the reverse link to a prospective desired serving sector. The channel quality characteristic reflects the strength in dB of the reference signals to and from each prospective desired serving sector. Handoff block 57 then weights the characteristic for the forward link and the characteristic for the reverse link in order to compute the magnitude of the weighted characteristic for each prospective desired serving sector. The magnitude of the weighted characteristic is expressed as:

Magnitude=w_{FL} ΔFL+w_{RL} ΔRL

In steps 90 and 93, handoff block 57 determines that a sector is the desired serving sector if the sector has the largest magnitude of the weighted characteristic of the group of sectors being analyzed, but only if that largest magnitude exceeds the magnitude of the weighted characteristic of the current serving sector by more than a predetermined hysteresis amount. The hysteresis amount is measured in dB. Thus, a prospective desired serving sector is determined to be the desired serving sector if the following condition is satisfied:

w_{FL} ΔDFLSS+w_{RL} ΔDRLSS>w_{FL} ΔFLSS+w_{RL} ΔRLSS+hysteresis amount.

In various embodiments, the weightings are applied in different ways. In one embodiment, three possible combinations of varying weightings are applied depending on how access terminal 18 is being used at the time of the handoff. If at the time of the handoff, the user is downloading data, such as a audio or video file, to access terminal 18, then the magnitude of a channel quality characteristic for the forward link is given a weighting of one, and the magnitude of a channel quality characteristic for the reverse link is given a weighting of zero. Handoff block 57 also uses the weighting w_{FL}=1 and w_{RL}=0 when the user of access terminal 18 is not sending any reverse link traffic. For the majority of time in normal operation, access terminal 18 operates in a downlink-centric manner, and the weighting w_{FL}=1 and w_{RL}=0 is used.

If at the time of the handoff, the user is uploading data from access terminal 18, for example to a web server, then the magnitude of a channel quality characteristic for the reverse link is given a weighting of one, and the magnitude of a channel quality characteristic for the forward link is given a weighting of zero. Handoff block 57 also uses the weighting w_{FL}=0 and w_{RL}=1 when the user of access terminal 18 is not receiving any forward link traffic, for example, because access terminal 18 has not received any forward link assignment within the last 100 ms. The weighting w_{FL}=0 and w_{RL}=1 is also used when access terminal 18 is link budget limited on the reverse link control channels. When the user is both receiving forward link traffic and sending reverse link traffic at the time of the handoff, a weighting of w_{FL}=0.5 and w_{RL}=0.5 is used.

In another embodiment, a static weighting is applied to the magnitudes of the forward link and reverse link characteristics. For example, handoff block 57 always applies the weighting w_{FL}=1 and w_{RL}=0 because access terminal 18 operates for the majority of time in a downlink centric manner. Alternatively, handoff block 57 always applies the weighting w_{FL}=0 and w_{RL}=1 because a particular user has a limited link budget for the reverse link control channels. It is also noted that the weightings 0, 1 and 0.5 may be adjusted according to design preference, and are just some of many possible weighting values that may be used.

The various illustrative blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Those of skill in the art will appreciate that the various illustrative blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present disclosure.

Where one or more exemplary embodiments are implemented in software, the functions may be stored on or transmitted over as one or more instructions or code on a computer-readable medium. Computer-readable media includes both computer storage media and communication media including any medium that facilitates transfer of a computer program from one place to another. Storage media may be any available media that can be accessed by a computer. Memory 44 of access terminal 18 is an example of such a computer-readable medium. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. An exemplary computer-readable storage medium is coupled to a processor such the processor can read information from, and write information to, the storage medium. DSP 43, firmware processor 45 and a software processor 46 of access terminal 18 are examples of processors that can read information from and write information to the storage medium of memory 44. In the alternative, the storage medium may be integral to the processor, such as DSP 43. The processor and the storage medium may reside in an ASIC. The ASIC may reside in a user terminal or access terminal 18. In the alternative, the processor and the storage medium may reside as discrete components in the user terminal or access terminal.

Although certain specific embodiments are described above for instructional purposes, the teachings of this patent document have general applicability and are not limited to the specific embodiments described above. For example, RSHM program 54 is described above as being resident on access terminal 18. RSHM program 54 may also, however, be resident on a sector, access point or base station. In some embodiments, multiple reference signal and handoff management programs are run simultaneously, with some portions of search block 56 and handoff block 57 resident on a base station and some portions resident on access terminal 18. Variations and modifications to the deployment of the reference signal and handoff management program may be developed without departing from the spirit and scope of the reference signal and handoff management system. Accordingly, various modifications, adaptations, and combinations of the various features of the described specific embodiments can be practiced without departing from the scope of the claims that are set forth below.

What is claimed is:

1. A method comprising:
detecting reference signals, wherein the detected reference signals are received over forward links from sectors;
allocating a plurality of the sectors to a group of sectors, wherein each of the plurality of sectors allocated to the group of sectors satisfies a reverse link channel quality constraint;
calculating a magnitude of a weighted characteristic of each sector in the group of sectors, wherein the weighted characteristic is weighted between the characteristic of a forward link of each sector and the characteristic of a reverse link of that sector; and
designating a desired serving sector from among the group of sectors, wherein the desired serving sector is the sector having the largest magnitude of the weighted characteristic.

2. The method of claim 1, wherein the characteristic is a difference between two channel quality values.

3. The method of claim 1, wherein the characteristic of the forward link is based on a difference between a reference signal energy of a forward link from a prospective desired serving sector and a reference signal energy of a forward link from a current serving sector.

4. The method of claim 1, wherein the characteristic of the reverse link is a difference between a channel quality value of a reverse link to a prospective desired serving sector and a channel quality value of a reverse link to a current serving sector.

5. The method of claim 1, wherein the reverse link channel quality constraint is based on a difference between two channel quality values being less than a predetermined maximum difference value.

6. The method of claim 1, wherein the detected reference signals are received by an access terminal, wherein the characteristic of the forward link has a first weighting, and the characteristic of the reverse link has a second weighting, wherein the first weighting and the second weighting sum to one, and wherein the first weighting and the second weighting change based on whether the access terminal is predominantly uploading data over the reverse link or downloading data over the forward link.

7. The method of claim 1, wherein the desired serving sector is designated to be a current serving sector if the magnitude of the weighted characteristic of the sector having the largest magnitude of the weighted characteristic does not exceed the magnitude of the weighted characteristic of the current serving sector by more than an hysteresis amount.

8. The method of claim 1, wherein the detected reference signals include a first reference signal and a second reference signal, wherein the first reference signal is transmitted from a current serving sector, wherein the second reference signal is transmitted from the desired serving sector, and wherein the current serving sector and the desired serving sector are asynchronous to one another.

9. The method of claim 1, wherein the detected reference signals include a first reference signal and a second reference signal, wherein the first reference signal is transmitted from a first sector that has a first configuration, and wherein the second reference signal is transmitted from a second sector that has a second configuration, and wherein the first configuration is different than the second configuration.

10. The method of claim 9, wherein the first configuration and the second configuration use the same system technology, and wherein the first configuration and the second configuration use different deployment parameters.

11. The method of claim 10, wherein the deployment parameters are time and frequency synchronization parameters.

12. The method of claim 11, wherein the time and frequency synchronization parameters of the first configuration differ from the time and frequency synchronization parameters of the second configuration due to lack of a common synchronization source.

13. The method of claim 10, wherein the different deployment parameters differ by a length of a cyclic prefix.

14. The method of claim 10, wherein the different deployment parameters differ by a number of Fast Fourier transform (FFT) tones used.

15. The method of claim 12, wherein the detected reference signals include a first reference signal and a second reference signal, wherein the first reference signal is transmitted from a current serving sector that has a first configuration, wherein the second reference signal is transmitted from the desired serving sector that has a second configuration, further comprising:
determining that the desired serving sector is asynchronous to the current serving sector by processing the second reference signal.

16. The method of claim 1, further comprising:
calculating a relative energy for each of the detected reference signals.

17. A method comprising:
detecting a plurality of reference signals including a first reference signal and a second reference signal, wherein the first reference signal is transmitted from a first sector that has a first configuration, and wherein the second reference signal is transmitted from a second sector that has a second configuration, and wherein the first configuration is different than the second configuration;
allocating a plurality of sectors to a first group of sectors, wherein each of the plurality of sectors allocated to the first group of sectors satisfies a reverse link channel quality constraint;
allocating to a second group of sectors those sectors from the first group of sectors that satisfy a reverse link budget constraint;
calculating a magnitude of a weighted characteristic of each sector in the second group of sectors, wherein the weighted characteristic is weighted between the characteristic of a forward link of each sector and the characteristic of a reverse link of that sector; and
designating a desired serving sector from among the second group of sectors, wherein the desired serving sector is the sector having the largest magnitude of the weighted characteristic.

18. The method of claim 17, wherein the characteristic is a difference between two channel quality values.

19. The method of claim 17, wherein the first reference signal and the second reference signal are received by an access terminal, wherein the characteristic of the forward link has a first weighting, and the characteristic of the reverse link has a second weighting, wherein the first weighting and the second weighting sum to one, and wherein the first weighting and the second weighting change based on whether the access terminal is predominantly uploading data over the reverse link or downloading data over the forward link.

20. The method of claim 17, wherein the desired serving sector is designated to be a current serving sector if the magnitude of the weighted characteristic of the sector having the largest magnitude of the weighted characteristic does not exceed the magnitude of the weighted characteristic of the current serving sector by more than an hysteresis amount.

21. The method of claim 17, wherein the first sector is a current serving sector, wherein the second sector is the desired serving sector, and wherein the current serving sector and the desired serving sector are asynchronous to one another.

22. The method of claim 17, wherein the first configuration and the second configuration use the same system technology, and wherein the first configuration and the second configuration use different deployment parameters.

23. The method of claim 22, wherein the deployment parameters are time and frequency synchronization parameters.

24. The method of claim 22, wherein the different deployment parameters differ by a length of a cyclic prefix.

25. A method comprising:
detecting a plurality of reference signals including a first reference signal and a second reference signal, wherein the first reference signal is transmitted from a current serving sector, wherein the second reference signal is transmitted from a second sector, and wherein the current serving sector and the second sector are asynchronous to one another;
allocating a plurality of sectors to a first group of sectors, wherein a reference signal transmitted from each sector allocated to the first group of sectors indicates that the sector satisfies a reverse link channel quality constraint;
allocating to a second group of sectors those sectors from the first group of sectors that satisfy a reverse link budget constraint;
determining that the second sector is a desired serving sector based on both the reverse link channel quality constraint and the reverse link budget constraint of the second sector; and
performing a handoff of an access terminal from the current serving sector to the desired serving sector.

26. The method of claim 25, further comprising:
calculating a magnitude of a weighted characteristic of each sector in the second group of sectors, wherein the weighted characteristic is weighted between the characteristic of a forward link of each sector and the characteristic of a reverse link of that sector; and
determining that the second sector is the desired serving sector based on the second sector having the largest magnitude of the weighted characteristic.

27. The method of claim 26, wherein the characteristic of the forward link is based on a difference between an energy of the second reference signal and an energy of the first reference signal.

28. The method of claim 26, wherein the characteristic of the reverse link is a difference between a channel quality value of a reverse link to the desired serving sector and a channel quality value of a reverse link to the current serving sector.

29. The method of claim 26, wherein the second sector is determined to be the desired serving sector based on the second sector having the largest magnitude of the weighted characteristic only if that largest magnitude exceeds a magnitude of the weighted characteristic of the current serving sector by more than an hysteresis amount, and wherein if that largest magnitude does not exceed the magnitude of the weighted characteristic of the current serving sector by more than the hysteresis amount, the desired serving sector is determined to be the current serving sector.

30. The method of claim 25, wherein the reverse link channel quality is a power of carrier over thermal (pCoT).

31. An access terminal, comprising:
a processor;
a storage medium; and
a reference signal and handoff management program stored on the storage medium, wherein the reference signal and handoff management program includes instructions that are executed by the processor to cause the access terminal to detect a plurality of reference signals, to allocate to a first group each sector from which a reference signal is detected indicating that the sector satisfies a reverse link channel quality constraint, to determine that a sector from the first group is a desired serving sector based on the reverse link channel quality of the sector, and to perform a handoff of the access terminal from a current serving sector to the desired serving sector.

32. The access terminal of claim 31, wherein the instructions that are executed by the processor cause the access terminal to calculate a magnitude of a weighted characteristic for each sector in the first group, wherein the weighted characteristic is weighted between the characteristic of a forward link of each sector and the characteristic of a reverse link of each sector in the first group, and wherein the sector from the first group is determined to be the desired serving sector based on the sector having the largest magnitude of the weighted characteristic.

33. The access terminal of claim 31, wherein the instructions that are executed by the processor cause the access terminal to allocate to a second group each sector from the first group for which a reference signal indicates that the sector satisfies a reverse link budget constraint.

34. The access terminal of claim 33, wherein the instructions that are executed by the processor cause the access terminal to calculate a magnitude of a weighted characteristic for each sector in the second group, wherein the weighted characteristic is weighted between the characteristic of a forward link of each sector and the characteristic of a reverse link of each sector in the second group, and wherein the sector from the second group is determined to be the desired serving sector based on the sector having the largest magnitude of the weighted characteristic.

35. The access terminal of claim 31, wherein the current serving sector and the desired serving sector are asynchronous to one another.

36. The access terminal of claim 31, wherein the current serving sector uses a different system technology than does the desired serving sector.

37. The access terminal of claim 31, wherein the reference signal and handoff management program comprises:
a handoff management module; and
firmware modules, wherein the handoff management module polls the firmware modules for link quality information obtained from the reference signals and applies the reverse link channel quality constraint to each sector from which a reference signal is detected.

38. The access terminal of claim 31, wherein the current serving sector has time and frequency synchronization parameters that differ from the time and frequency synchronization parameters of the desired serving sector due to lack of GPS synchronization.

39. The access terminal of claim 31, wherein the reference signal and handoff management program calculates a relative energy and a reference signal energy for each detected reference signal.

40. A computer program product, comprising:
a computer-readable medium comprising:
code for causing a computer to manage handoffs by detecting reference signals, wherein the detected reference signals are received over forward links from sectors;
code for causing the computer to manage handoffs by allocating a plurality of the sectors to a group of sectors, wherein each of the plurality of sectors allocated to the group of sectors satisfies a reverse link channel quality constraint;
code for causing the computer to manage handoffs by calculating a magnitude of a weighted characteristic of each sector in the group of sectors, wherein the weighted characteristic is weighted between the characteristic of a forward link of each sector and the characteristic of a reverse link of that sector;
code for causing the computer to manage handoffs by designating a desired serving sector from among the group of sectors, wherein the desired serving sector has the largest magnitude of the weighted characteristic from among the group of sectors; and
code for causing the computer to manage handoffs by performing a handoff of an access terminal from a current serving sector to the desired serving sector.

41. The computer program product of claim 40, wherein the characteristic is a difference between two channel quality values.

42. The computer program product of claim 40, wherein the detected reference signals include a first reference signal and a second reference signal, wherein the first reference signal is transmitted from a current serving sector, and the second reference signal is transmitted from the desired serving sector, and wherein the computer-readable medium further comprises:
code for causing the computer to manage handoffs by determining that the desired serving sector is asynchronous to the current serving sector by processing the second reference signal.

43. The computer program product of claim 40, wherein the computer-readable medium further comprises:
code for causing the computer to manage handoffs by calculating a relative energy for each of the detected reference signals.

44. A computer program product, comprising:
a computer-readable medium comprising:
code for causing a computer to manage handoffs by detecting a plurality of reference signals including a first reference signal and a second reference signal, wherein the first reference signal is transmitted from a current serving sector, wherein the second reference signal is transmitted from a second sector, and wherein the current serving sector and the second sector are asynchronous to one another;
code for causing the computer to manage handoffs by allocating a plurality of sectors to a first group of sectors, wherein a reference signal transmitted from each sector allocated to the first group of sectors indicates that the sector satisfies a reverse link channel quality constraint;
code for causing the computer to manage handoffs by allocating to a second group of sectors those sectors from the first group of sectors that satisfy a reverse link budget constraint; and
code for causing the computer to manage handoffs by determining that the second sector is a desired serving sector based on both the reverse link channel quality constraint and the reverse link budget constraint of the second sector.

45. The computer program product of claim 44, wherein the computer-readable medium further comprises:
code for causing the computer to manage handoffs by performing a handoff of an access terminal from the current serving sector to the desired serving sector.

46. The computer program product of claim 44, wherein the computer-readable medium further comprises:
code for causing the computer to manage handoffs by calculating a magnitude of a weighted characteristic of each sector in the second group of sectors, wherein the weighted characteristic is weighted between the characteristic of a forward link of each sector and the characteristic of a reverse link of that sector; and
code for causing the computer to manage handoffs by determining that the second sector is the desired serving sector based on the second sector having the largest magnitude of the weighted characteristic.

47. The computer program product of claim 44, wherein the reverse link channel quality is a power of carrier over thermal (pCoT).

48. A device comprising:
a receiver on an access terminal that receives a plurality of reference signals from sectors; and
means for detecting the plurality of reference signals, for allocating one or more sectors to a first group of sectors based on a reverse link channel quality constraint, for calculating a magnitude of a weighted characteristic of one or more sectors in the first group of sectors, and for designating a desired serving sector as the sector having the largest magnitude of the weighted characteristic.

49. The device of claim 48, wherein the means is also for allocating to a second group of sectors those sectors from the first group of sectors that satisfy a reverse link budget constraint.

50. The device of claim 48, wherein the means is also for performing a handoff of the access terminal from a current serving sector to the desired serving sector.

51. The device of claim 48, wherein the weighted characteristic is weighted between the characteristic of a forward link of a sector and the characteristic of a reverse link of that sector.

52. The device of claim 48, wherein the characteristic is a difference between two channel quality values.

53. The device of claim 48, wherein the means includes a handoff management module and a firmware modules, and wherein the handoff management module polls the firmware modules for link quality information obtained from the reference signals and applies the reverse link channel quality constraint to each sector from which a reference signal is detected.
